(19) United States
(12) Patent Application Publication
(10) Pub. No.: US 2005/0022671 A1
(43) Pub. Date: Feb. 3, 2005

(54) Chemical filter and method for manufacturing same

(75) Inventors: Teruzi Yamazaki, Yokohama-shi (JP); Toshiro Nakano, Yokohama-shi (JP); Akihiro Imai, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NICHIAS Corporation, Tokyo (JP)

(21) Appl. No.: 10/890,145

(22) Filed: Jul. 14, 2004

(30) Foreign Application Priority Data
Jul. 31, 2003 (JP) 283629/2003

(51) Int. Cl. B01D 53/02

(52) U.S. Cl. 96/108

(57) ABSTRACT

A chemical filter comprising an ion-exchange resin powder attached to the surface and inside of a fiber paper, which forms a corrugated honeycomb substrate, using an adhesive is disclosed. The average particle diameter of the ion-exchange resin powder is preferably 1-150 μm. In addition, the ion-exchange resin powder preferably has an ion-exchange capacity of 1-10 meq/g. A method for manufacturing the chemical filter is also disclosed. The method comprises spraying or shower-coating a slurry mixture of an ion-exchange resin powder and an adhesive onto a corrugated honeycomb substrate, or dipping the corrugated honeycomb substrate in a slurry mixture.

### TECHNICAL FIELD

The present invention relates to a chemical filter for air cleaning used in clean rooms and apparatuses in facilities for manufacturing semiconductors, liquid crystals, and precision electronic parts in which ionized gaseous pollutants are produced, and to a method for manufacturing the chemical filter.

### BACKGROUND ART

In frontier industries such as the semiconductor manufacturing industry and liquid crystal manufacturing industry, controlling pollution of the air and product surfaces in clean rooms to prevent pollution is important to ensure a high yield, high quality, and reliability of the products. In the semiconductor manufacturing industry, in particular, as the degree of integration of the products increases, control of ionized gaseous pollutants has become indispensable in addition to the control of particulate matters using a HEPA filter, ULPA, and the like.

In the present invention, ionized gaseous pollutants indicate basic gases and acidic gases. Of these gases, the basic gases such as ammonia are known to adversely affect resolution during the step of exposure to radiation and cause wafer surfaces to become clouded in the manufacture of semiconductor devices. SO_{X}, which is an acidic gas, produces lamination defects in substrates in the thermal oxidation membrane-forming process during manufacture of semiconductors, whereby the characteristics and reliability of the semiconductor devices are adversely affected.

Since ionized gaseous pollutants cause various problems in semiconductor manufacturing processes and the like in this manner, it is desired to reduce the concentration of the ionized gaseous pollutants in a clean room used in semiconductor manufacturing and the like to several tens of ppb or less.

Japanese Patent Application Laid-open No. 2001-259339 (Patent Document 1) discloses an air filter material in the form of paper comprising a matrix and powder of ion exchange resin having a particle size and ion exchange capacity in specific ranges incorporated into the matrix. The air filter material is formed of paper milled by sufficiently dispersing the ion exchange resin powder in the matrix. Fine particles of ion exchange resin are held on the surface of the pulp matrix by means of an electrostatic force and frictional force so that the fine particles are detached from the matrix only with difficulty. The amount of gas adsorbed is increased by using this air filter material.

Japanese Patent Application Laid-open No. 2000-5544 (Patent Document 2) discloses a deodorant comprising an adsorption medium such as activated carbon, zeolite, or silica gel and an ion-exchange resin. The ion-exchange resin and bad-smelling components once adsorbed in the deodorant can be released only with difficulty from the adsorption medium even in an environment exposed to water.

Japanese Patent Application Laid-open No. 2003-10613 (Patent Document 3) discloses an air filter material comprising a filtering matrix containing powder of an ion-exchange resin and phosphoric acid attached to the matrix by immersion or the like. Due to a large amount of phosphoric acid carried on the filter material, the amount of alkaline ionized gases adsorbed markedly increases.
(Patent Document 1) Japanese Patent Application Laid-open No. 2001-259339 (pages 2 and 4)
(Patent Document 2) Japanese Patent Application Laid-open No. 2000-5544 (pages 2 and 5)
(Patent Document 3) Japanese Patent Application Laid-open No. 2003-10613 (pages 2 and 6)

However, in the air filter material described in Document 1, if a large amount of fine particles of ion exchange resin is attached to the pulp matrix to sufficiently remove ionized gaseous pollutants, the fine particles of ion exchange resin are easily detached from the matrix because the fine particles are held on the surface of the matrix by means of an electrostatic force or frictional force. If the amount of the fine particles of ion exchange resin is limited to the amount that can be held by the electrostatic force or frictional force, the ionized gaseous pollutants cannot be sufficiently removed.

The deodorant described in Patent Document 2 comprises a mixture of an adsorption medium such as activated carbon and an ion-exchange resin milled into paper. Since it is difficult to increase the amount of ion-exchange resin attached by employing a method of milling paper together with the adsorption medium, ionized gaseous pollutants cannot be sufficiently removed.

The air filter material described in Patent Document 3 is manufactured by milling a mixture of a fibrous material such as pulp and an ion-exchange resin into paper and further adding phosphoric acid. For the same reasons as in the case of the deodorant described in Document 2, it is difficult to increase the amount of ion-exchange resin attached using the method of milling the ion-exchange resin together with fibrous material. Thus, the problem of insufficient removal of ionized gaseous pollutants remains. This filter material removes ionized gaseous pollutants by the neutralization reaction with phosphoric acid. The salt produced by the reaction of the ionized gaseous pollutants with phosphoric acid inhibits dispersion of the gas to be filtered into the inside of the filter. Therefore, the ionized gaseous pollutants cannot sufficiently react with phosphoric acid, resulting in insufficient removal of the ionized gaseous pollutants.

An object of the present invention is, therefore, to provide a chemical filter exhibiting improved capability of removing ionized gaseous pollutants due to an increased amount of ion-exchange resin powder attached to a substrate, which can be detached from the filter only with difficulty, and exhibiting only a small pressure loss, and a method for preparing the chemical filter.

### SUMMARY OF THE INVENTION

As a result of extensive studies to achieve the above object, the inventors of the present invention have found that a large amount of ion-exchange resin powder can be attached to the surface and inside of fiber paper forming a corrugated honeycomb substrate by spraying or shower-coating a slurry mixture of the ion-exchange resin powder and an adhesive onto the corrugated honeycomb substrate or by dipping the corrugated honeycomb substrate into the slurry mixture. This finding has led to the completion of the present invention.

Specifically, a present invention (1) provides a chemical filter comprising an ion-exchange resin powder attached to the surface and inside of a fiber paper forming a corrugated honeycomb substrate using an adhesive.

A present invention (2) provides the above chemical filter, wherein the ion-exchange resin powder has an average particle diameter of 1-150 μm.

A present invention (3) provides the above chemical filter, wherein the ion-exchange resin powder has an ion-exchange capacity of 1-10 meq/g.

A present invention (4) provides the above chemical filter, wherein the ion-exchange resin powder comprises anion-exchange resin powder and cation-exchange resin powder.

A present invention (5) provides the above chemical filter, wherein the adhesive comprises at least one of inorganic adhesives or organic adhesives.

A present invention (6) provides a method for manufacturing a chemical filter comprising spraying or shower-coating a slurry mixture of an ion-exchange resin powder and an adhesive onto a corrugated honeycomb substrate.

A present invention (7) provides a method for manufacturing a chemical filter comprising dipping a corrugated honeycomb substrate in a slurry mixture of an ion-exchange resin powder and an adhesive.

Since it is possible to firmly attach a large amount of ion-exchange resin powder to the surface as well as to the inside of the fiber paper forming a substrate, the amount of ionized gaseous pollutants reacted per unit volume of the chemical filter of the present invention (1) can be significantly increased, whereby the ionic gaseous pollutant removal life of the chemical filter can be extended. In addition, since the corrugated honeycomb substrate allows the flow path for the process air to run parallel to the airflow direction, the pressure drop can be reduced. Therefore, it is possible to employ compact peripheral equipment and reduce costs.

Using the chemical filter of the present invention (2), adhesion of ion-exchange resin powder to the fiber paper can be increased, whereby it is possible to reduce detachment of ion-exchange resin powder from the substrate.

Using the chemical filter of the present invention (3), the amount of ionized gaseous pollutants reacted per unit volume of the filter can be increased.

Using the chemical filter of the present invention (4), both basic gases (ammonia, amines, etc.) and acidic gases (SO_{X}, NO_{X}, etc.) can be removed.

Using the chemical filter of the present invention (5), the ion-exchange resin powder can be firmly attached to both the surface and inside of the fiber paper.

Using the method for manufacturing the chemical filter of the present inventions (6) and (7), a large amount of ion-exchange resin powder can be firmly attached to a substrate in the manner that the ion-exchange resin powder can be detached only with difficulty. The resulting chemical filter exhibits excellent performance of removing ionized gaseous pollutants and a small pressure loss.

### BRIEF DESCRIPTION OF THE DRAWINGS

FIG. 1 is a typical perspective view of the corrugated honeycomb substrate used in the present invention.

FIG. 2 is a typical cross-sectional view of the corrugated honeycomb substrate used in the present invention.

FIG. 3 is a graph showing the change over time of the ammonia gas removal rate.

### DETAILED DESCRIPTION OF THE INVENTION AND PREFERRED EMBODIMENT

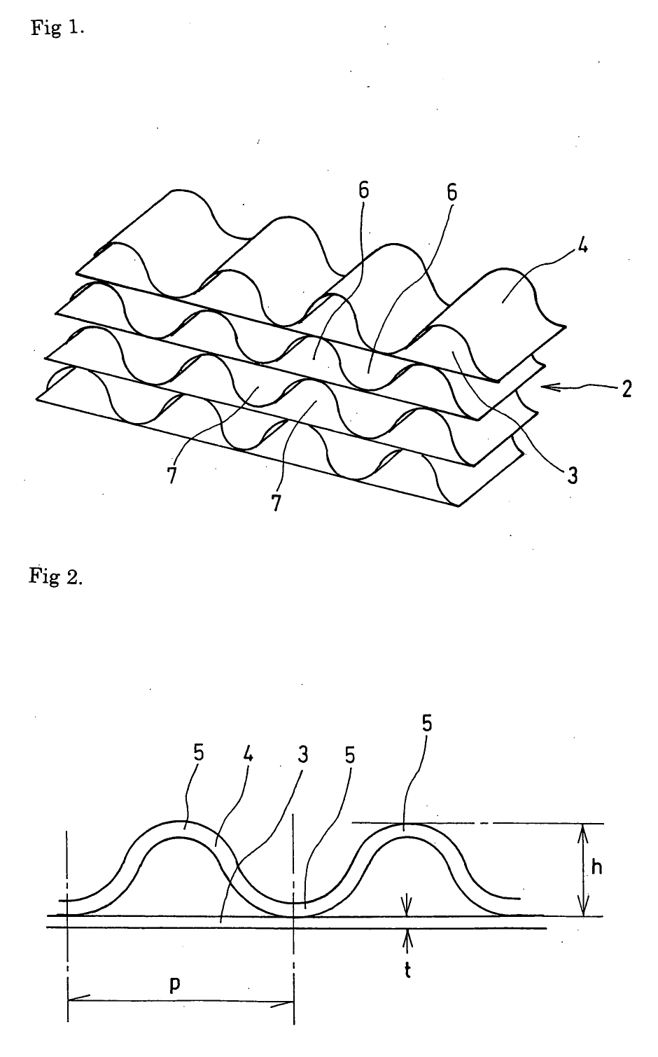

FIG. 1 is a typical perspective view of the corrugated honeycomb substrate used in the present invention. The corrugated honeycomb substrate 2 is formed from a flat fiber paper 3 and a corrugated fiber paper 4 alternately laminated. A nearly half-cylindrical cave 6 extending in the direction of the continuous mountain 5 of the corrugated fiber paper 4 is formed between the flat fiber paper 3 and the corrugated fiber paper 4. The chemical filter of the present invention is formed from the corrugated honeycomb substrate 2 having such a structure and ion-exchanged resin powder attached thereto using an adhesive, and is designed to pass the air to be processed introduced from an opening 7 through the cave 6.

In the present invention, the flat fiber paper 3 is a flat material made of fiber paper and the corrugated fiber paper 4 is a waveform object formed by corrugating fiber paper. Corrugating is a process for fabricating a flat material such as the flat fiber paper 3 into a waveform object by passing the flat fiber paper through a pair of upper and lower corrugated rolls.

Fiber paper used in the present invention means woven fabric or nonwoven fabric formed from fiber. As the fiber paper, inorganic fiber papers made from inorganic fibers such as silica alumina fiber, silica fiber, alumina fiber, mullite fiber, glass fiber, rock wool fiber, and carbon fiber; and organic fiber papers made from organic fibers such as polyethylene fiber, polypropylene fiber, nylon fiber, polyester fiber, polyvinyl alcohol fiber, aramid fiber, pulp fiber, and rayon fiber can be given. Of these fiber papers, inorganic fiber papers, particularly silica alumina fiber paper, are preferable to produce a chemical filter with a high mechanical strength.

The average diameter of the fiber forming the fiber papers is usually in the range of 0.1-25 μm, and preferably 0.5-10 μm, and the average fiber length is usually in the range of 0.1-50 mm, and preferably 10-20 mm. The average diameter and length of the fiber in the above range are desirable to increase the mechanical strength of the fiber paper. The above fiber papers can be used either individually or in combination of two or more.

The fiber paper has an inter-fiber void ratio usually of 50-95%, and preferably of 70-95%. The inter-fiber void ratio here indicates a quotient obtained by dividing the total void volume of the fiber paper by the apparent volume of the fiber paper. The void ratio in the above range is preferable, because it is easy to attach a large amount of ion exchange resin powder not only to the surface, but also to the inside of the fiber paper. The thickness of the fiber paper (t in FIG. 2) is usually 0.1-0.5 mm, and preferably 0.2-0.3 mm. The thickness in the above range is preferable, because it is possible to increase the mechanical strength of the fiber paper and to attach a large amount of ion exchange resin powder to the inside of the fiber paper.

The corrugated honeycomb substrate 2 of the present invention can be prepared by alternately laminating the flat fiber paper 3 and the corrugated fiber paper 4 using the corrugated fiber paper 4 as a center core. In this instance, the flat fiber paper 3 and the corrugated fiber paper 4 of the center core may be integrated by causing upper mountains 5 and lower mountains 5 on the corrugated fiber paper 4 (the center core) to adhere to the flat fiber paper 3 using an adhesive, or a laminated body of the flat fiber papers 3 and the corrugated fiber papers 4 may be secured in a frame without adherence. As the adhesive used for adhering the flat fiber paper 3 to the corrugated fiber paper 4, the same type of inorganic adhesives such as silica sol mentioned later can be given.

FIG. 2 is a typical cross-sectional view of the corrugated honeycomb substrate 2 along the plane parallel to an opening 7. In FIG. 2, the mountains 5 of the corrugated fiber paper 4 are caused to adhere to the flat fiber papers 3. The height of the mountains (h in FIG. 2) of the corrugated honeycomb substrate 2 is usually 0.5-10 mm, preferably 1-5 mm, and particularly preferably 1-2 mm. The pitch of the mountains (p in FIG. 2) of the corrugated honeycomb substrate 2 is usually 1-20 mm, preferably 1-5 mm, and particularly preferably 2-4 mm. The mountain height and the pitch length in the above ranges are preferable to maintain a good balance between ionic gaseous pollutant removal efficiency and pressure loss.

In the present invention, the ion-exchange resin powder is attached to both the surface and inside of the flat fiber paper 3 and corrugated fiber paper 4 forming the corrugated honeycomb substrate 2. The inside herein indicates the void formed between fibers of woven fabric or nonwoven fabric of fiber paper. As the ion-exchange resin powder used in the present invention, at least one of cation exchange resin powder or anion exchange resin powder can be given, for example. A strongly acidic cation exchange resin, for example, can be given as the cation exchange resin forming the cation exchange resin powder. A strong basic anion exchange resin, for example, can be given as the anion exchange resin forming the anion exchange resin powder.

The ion-exchange resin powder used in the present invention has an average diameter usually of 1-150 μm, and preferably 10-50 μm. If the average diameter is more than 150 μm, the weight of each particle is too large to have sufficient adhesion strength with an adhesive, which may result in detachment of the ion-exchange resin powder. If the average diameter is less than 1 μm, a viscosity of the slurry mixture of the ion-exchange resin powder and the adhesive has too large so that it is difficult to obtain fiber paper sufficiently impregnated with the slurry mixture by a spraying or dipping method. Only a small amount of the ion-exchange resin powder can attach to the fiber paper.

The ion-exchange resin powder has an ion-exchange capacity usually of 1-10 meq/g, and preferably 3-6 meq/g. If the ion-exchange capacity is less than 1 meq/g, the ion-exchange resin powder exhibits only insufficient reactivity with ionized gaseous pollutants and its performance in removing the ionized gaseous pollutants tends to decrease. If the ion-exchange capacity is more than 10 meq/g, the ion-exchange resin forming the ion-exchange resin powder has only poor chemical stability and the ion-exchange groups tend to be released from the ion-exchange resin powder.

Ion-exchange resin powder containing both cation-exchange resin powder and anion-exchange resin powder is preferable because of the capability of removing both basic gases (ammonia, amines, etc.) and acidic gases (SO_{X}, NO_{X}, etc.).

When the ion-exchange resin powder contains both cation-exchange resin powder and anion-exchange resin powder, their mixing ratio by weight is 2:8 to 8:2, and preferably 4:6 to 6:4. If the mixing ratio is outside of this range, the reactivity of either the cation-exchange resin powder or anion-exchange resin powder with ionized gaseous pollutants tends to decrease.

There are no specific limitations to the adhesive used for attaching ion-exchange resin powder to the fiber paper. Inorganic adhesives and organic adhesives can be given as examples. An adhesive containing either an inorganic adhesive or an organic adhesive is sufficient for use in the present invention. As the inorganic adhesive, silica sol, alumina sol, titania sol, sodium silicate, potassium silicate, and the like can be given. As the organic adhesive, acrylic resin, vinyl-acetate resin, epoxy resin, phenol resin, silicone resin, their copolymer resins, and the like can be given. Of these, inorganic adhesives are preferable because the cured products of the inorganic adhesives do not produce films but produce flocculants which provide spaces through which ionized gaseous pollutants can easily permeate and be removed at a high rate.

The chemical filter of the present invention can be prepared by subjecting a corrugated honeycomb substrate to a spraying treatment or a shower-coating treatment using a slurry mixture of an ion-exchange resin powder and an adhesive or to a dipping treatment using the slurry mixture. The spraying treatment herein refers to a method of spraying the above slurry mixture onto the corrugated honeycomb substrate; the shower-coating treatment refers to a method of spraying the above slurry mixture onto the corrugated honeycomb substrate using a showering facility or the like that can allow the slurry mixture to flow down like a shower; and the dipping treatment refers to a method of dipping the corrugated honeycomb substrate in the above slurry mixture to cause the slurry mixture to contact the corrugated honeycomb substrate. Of these, the dipping treatment is preferable, because it is easy to attach a large amount of ion exchange resin powder not only to the surface but also to the inside of the fiber paper in one treatment. The spraying treatment, shower-coating treatment, and dipping treatment may be carried out two or more times either individually or in combination. A large amount of ion-exchange resin powder can be attached by repeating these treatments.

The slurry mixture can be obtained by mixing the ion-exchange resin powder, the adhesive, and water. A surfactant such as a dispersant can be optionally added. When an adhesive containing water is used, the water in the adhesive may be used as the water for the slurry mixture, although water may be separately added to the slurry mixture. For example, when the adhesive is silica sol, water other than that in the silica sol can be used as the water forming the slurry mixture. When the adhesive is an inorganic adhesive, the ratio by weight of solid components in the ion-exchange resin powder and the inorganic adhesive is 90:10 to 50:50, and preferably 85:15 to 75:25. When the adhesive is an organic adhesive, the ratio by weight of solid components in the ion-exchange resin powder and the organic adhesive is 99:1 to 80:20, and preferably 95:5 to 85:15. The concentration of the slurry mixture, specifically, the ratio of the total weight of solid components in the ion-exchange resin powder and adhesive to the total weight of the slurry mixture is usually 10-50 wt %, and preferably 20-40 wt %. The mixing ratio and the concentration of the slurry mixture in the above ranges can ensure sufficient attachment of the ion-exchange resin powder in the slurry mixture to the surface and the inside of the fiber paper by spraying or dipping treatment of the corrugated honeycomb substrate with the slurry mixture.

In addition, a drying treatment after the spraying, shower-coating, or dipping treatment with the slurry mixture is preferable for ensuring rapid attachment of the ion-exchange resin powder to the surface and inside of the fiber paper with the adhesive. Although there are no specific limitations, the drying treatment is carried out usually at a temperature of 50-130° C. for 30-120 minutes. When the spraying, shower-coating, or dipping treatment is carried out several times, a drying treatment between each of these treatments is preferable, because the spraying treatment or the like after firm attachment of ion-exchange resin powder can increase the attached amount of ion-exchange resin powder. Because the ion-exchange resin is attached to the chemical filter of the present invention in the form of a powder, the chemical filter has a large ion exchange capacity per unit volume, a long life, and a small pressure loss with a small amount of ion-exchange resin attached thereto as compared with the case in which ion-exchange resin fiber is used. The ion exchange capacity per unit volume can be 750 eq/m³ or more, for example.

The chemical filter of the present invention can be used as a chemical filter for cleaning air in clean rooms and apparatuses in which ionized gaseous pollutants are produced in plants and the like for manufacturing semiconductors, liquid crystals, and precision electronic parts, particularly in a chemical filter for reducing the concentration of ionized gaseous pollutants to 10 ppb or less.

### EXAMPLES

The present invention will now be described in detail by way of examples and comparative examples, which are given as embodiments and are not intended to limit the present invention.

### Example 1

(Preparation of Corrugated Honeycomb Substrate)

A waveform fiber paper to be used as a center core was prepared by passing a flat fiber paper of silica alumina fiber (average fiber diameter: 5 μm, average fiber length: 20 mm) with an inter fiber void ratio of 90% and a thickness (t in FIG. 2) of 0.2 mm through a pair of upper and lower waveform corrugators. After applying silica sol to the mountain parts of the center core as an adhesive, the flat fiber papers were superposed and laminated. The center core and the flat fiber paper were laminated in turn in the manner such that the air passages of the center cores are aligned in the same direction, thereby obtaining a corrugated honeycomb substrate shown in FIG. 1 and FIG. 2 with a center core pitch (p in FIG. 2) of 2.8 mm and a mountain height (h in FIG. 2) of 1.3 mm.

(Preparation of Slurry Mixture)

A slurry mixture with a solid content (slurry concentration) of 30 wt % was prepared by mixing strongly acidic cation-exchange resin powder with an average particle diameter of 20 μm and an ion-exchange capacity of 5.0 meq/g (DIAION manufactured by Mitsubishi Chemical Corp.) and silica sol to be used as an adhesive in a proportion to make the ratio of the solid components of the cation-exchange resin powder and silica sol 8:2.

(Preparation of Chemical Filter)

The ion-exchange resin powder was attached to the surface and inside of the corrugated honeycomb substrate by dipping the corrugated honeycomb substrate in its entirety in the slurry mixture in a container for 60 seconds (first dipping treatment), removing the substrate from the slurry, and drying at 80° C. for 60 minutes. This dipping treatment and drying were repeated once again (second dipping treatment) to further firmly attach the ion-exchange resin powder onto the surface of the corrugated honeycomb substrate.

The corrugated honeycomb substrate in which the ion-exchange resin powder has been firmly attached thus obtained was cut to a size of 100 mm (length)×100 mm (width)×70 mm (thickness) and inserted into an aluminum frame as an ion-exchange chemical filter.

The ion exchange capacity per unit volume of the chemical filter was 750 eq/m³ and the amount of the ion-exchange resin powder attached per unit volume of the chemical filter was 150 kg/m³. The ion exchange capacity per unit volume was determined by multiplying the weight of the attached ion-exchange resin powder by the ion exchange capacity of the ion-exchange resin powder.

(Measurement of Properties)

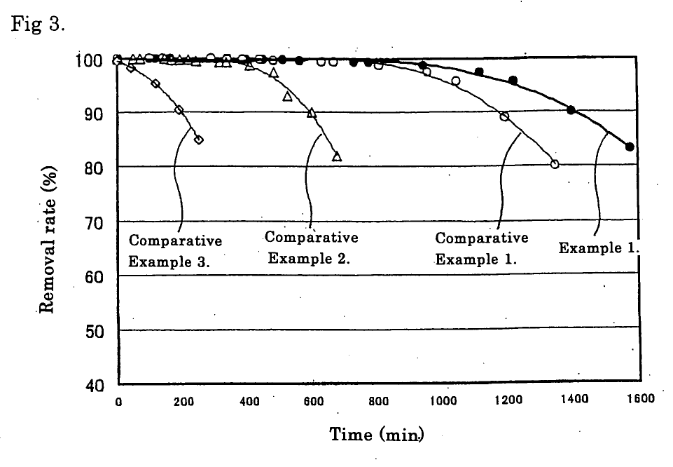

The change in the ammonia removal rate over time and the life of the chemical filter were determined under the following conditions. Although the ammonia concentration causing problems in a clean room in practice is in the order of ppb by weight (several parts by weight per one billion parts by weight), the ammonia concentration of 200 ppb by weight was used in the accelerated test. The results are shown in FIG. 3. The life of the chemical filter was 1400 hours. The period of time elapsed up to the time when the ammonia removal rate was decreased to as low as 90% was regarded as the life of the chemical filter. The pressure loss of the chemical filter determined under these conditions was 35 Pa. The results are shown in Table 1.

Test Conditions

Composition of feed gas: air containing 200 wt ppb of ammonia
Temperature and humidity of the feed gas: 23° C., 50% RH
Target gas to be removed: ammonia
Gas feed rate: 0.5 m/sec
Thickness of chemical filter: 70 mm

### Comparative Example 1

A commercially available chemical filter (pitch: 3.3 mm, mountain height: 1.1 mm) with a size of 100 mm (length)×100 mm (width)×70 mm (thickness), prepared from a flat fiber paper similar to a filter paper, which was prepared from a multiple center island-type ion-exchange fiber containing cation-exchange groups (ion-exchange capacity: 3.5 meq/g) and heat-sealed fiber by paper milling, by obtaining a waveform fiber paper by corrugating the flat fiber paper and laminating the waveform fiber paper thus obtained with the flat fiber paper by alternately superposing them, was used. The ion exchange capacity per unit volume of the chemical filter was 700 eq/m³ and the amount of the ion-exchange resin fiber per unit volume of the chemical filter was 200 kg/m³.

The change in the ammonia removal rate over time and the life of the chemical filter were determined under the same conditions as used in Example 1. The results are shown in FIG. 3. The life of the chemical filter was 1200 hours. The pressure loss of the chemical filter determined in the same manner as in Example 1 was 40 Pa. The results are shown in Table 1.

### Comparative Example 2

A commercially available chemical filter (length: 100 mm, width: 100 mm, thickness: 70 mm) prepared from a non-woven fabric made from an organic polymer by irradiating the polymer with ionizing radiation followed by grafting cation-exchange groups (sulfonic acid groups) by folding the non-woven fabric in the form of a pleat was used. The ion exchange capacity per unit volume of the chemical filter was 175 eq/m³ and the amount of the ion-exchange resin fiber per unit volume of the chemical filter was 60 kg/m³.

The change in the ammonia removal rate over time and the life of the chemical filter were determined under the same conditions as used in Example 1. The results are shown in FIG. 3. The life of the chemical filter was 600 hours. The pressure loss of the chemical filter determined in the same manner as in Example 1 was 59 Pa. The results are shown in Table 1.

### Comparative Example 3

A commercially available honeycomb chemical filter (length: 100 mm, width: 100 mm, thickness: 70 mm) prepared from activated carbon fiber to which phosphoric acid was attached was used.

The change in the ammonia removal rate over time and the life of the chemical filter were determined under the same conditions as used in Example 1. The results are shown in FIG. 3. The life of the chemical filter was 193 hours. The pressure loss of the chemical filter determined in the same manner as in Example 1 was 40 Pa. The results are shown in Table 1.

TABLE 1

| | Exam- | Comparative | Comparative | Comparative |
|---|---|---|---|---|
| | ple 1 | Example 1 | Example 2 | Example 3 |
| Ion exchange | 750 | 700 | 175 | —^{*1} |
| capacity per unit | | | | |
| volume (eq/m³) | | | | |
| Ion exchange resin | 150 | 200 | 60 | —^{*1} |
| per unit volume | | | | |
| (kg/m³) | | | | |
| Life of chemical | 1400 | 1200 | 600 | 193 |
| filter (hour) | | | | |
| Pressure loss | 35 | 40 | 59 | 40 |
| (Pa) | | | | |

^{*1}Not measured because the chemical filter did not contain an ion exchange resin.

1. A chemical filter comprising an ion-exchange resin powder attached to the surface and inside of a fiber paper, which forms a corrugated honeycomb substrate, using an adhesive.

2. The chemical filter according to claim 1, wherein the average particle diameter of the ion-exchange resin powder is 1-150 μm.

3. The chemical filter according to claim 1 or claim 2, wherein the ion-exchange capacity of the ion-exchange resin powder is 1-10 meq/g.

4. The chemical filter according to claims 1, wherein the ion-exchange resin powder comprises anion-exchange resin powder and cation-exchange resin powder.

5. The chemical filter according to claims 1, wherein the adhesive comprises at least one of inorganic adhesives or organic adhesives.

6. A method for manufacturing a chemical filter comprising spraying or shower-coating a slurry mixture of an ion-exchange resin powder and an adhesive onto a corrugated honeycomb substrate.

7. A method for manufacturing a chemical filter comprising dipping a corrugated honeycomb substrate in a slurry mixture of an ion-exchange resin powder and an adhesive.
